(19) United States
(12) Patent Application Publication
(10) Pub. No.: US 2003/0175663 A1
(43) Pub. Date: Sep. 18, 2003

(54) Three-dimensional head model used as a teaching aid for hairdressers and method for producing a head model

(76) Inventor: Manfred Fuchs, Vienna (AT)

Correspondence Address: ALTHEIMER & GRAY, TEN SOUTH WACKER DRIVE, SUITE 4000, CHICAGO, IL, 60606-7482, US

(21) Appl. No.: 10/203,449

(22) PCT Filed: Feb. 5, 2001
(86) PCT No.: PCT/AT01/00027

(30) Foreign Application Priority Data
Feb. 8, 2000 (AT) A 198/2000

(51) Int. Cl. G09B 19/10

(52) U.S. Cl. 434/94

(57) ABSTRACT

The invention relates to a three-dimensional head model (1) to be used as an instructional aid for hairdressers, including a plurality of elements (3) constituting hairs, which elements (3) are detachably connectable with the head model (1). In order to develop such a head model (1) which enables the visual and reproducible instruction of future hairdressers and which is to be handleable and producible in as simple a manner as possible, it is provided that the elements (3) are made of a plastically deformable material. The plastic deformability enables both the representation of the desired hairstyle in any desired position and the projection of the cut pattern in any desired direction. The invention, furthermore, relates to the development of as cost-effective a method as possible for producing such a head model (1).

The invention relates to a three-dimensional head model to be used as an instructional aid for hairdressers according to the characterizing clause of claim 1 as well as a method for producing such a head model.

Various techniques and instructional aids ate known for training and instruction purposes of hairdressers, but in most cases these enable but two-dimensional representations of hairdos or cut projections.

A three-dimensional model for instruction purposes is known, for instance, from U.S. Pat. No. 5,252,974 A. That system comprises three-dimensional head model parts which may be attached to a metal plate by the aid of magnets. Magnetic strips that constitute hairs may be arranged in the plane of the metal plate according to the projections desired. The strips cannot be varied in shape.

From U.S. Pat. No. 4,403,962 A, a three-dimensional head, model is known, which is provided with human or artificial hairs for the purpose of demonstrating cutting techniques. Special markings are additionally applied to the head surface to support the instruction techniques. The analysis of a haircut is feasible only by a short-time projection of the hairs into a defined position using one's fingers.

U.S. Pat. No. 5,586,696 A describes a three-dimensional head model for use in hair cutting and hair styling practices, which is comprised of a helmet-like construction including holes through which a material constituting hairs is passed. The synthetic hair is wound on a roll located below the helmet. The synthetic hair can, thus, be renewed in a simple manner after each haircut. Two helmet-like parts mutually arranged one within the other and capable of being relatively displaced constitute a locking mechanism that prevents the hairs from being pulled out of the interior of the head model. That head model does not enable a cut analysis by a projection of the hair-constituting elements.

FR 2 752 700 A1 relates to a head model as an instructional aid for hairdressers, whose surface comprises depressions into which lamellar elements may be inserted by means of appropriate pins. Those lamellar elements enable different projections of cut patterns. On the surface of the head model, markings corresponding to the usual cutting and projection directions are, moreover, provided. Also that projection does not allow any alteration of the hair-constituting elements in terms of shape.

Furthermore, instruction techniques are known in which hairstyles and projections of the respectively required cut courses may be presented by means of video recordings.

Earlier instructional aids for hairdressers, therefore, have only enabled either the representation and alteration of haircuts or the realization of projections to obtain certain hairdos. Models to be used for the three-dimensional illustration of both the desired hairstyles and the respectively required cut courses have not been known to date.

The object of the present invention resides in the development of a three-dimensional head model of the initially defined kind, which enables the visual and reproducible instruction of future hairdressers. The head model is to be handleable and-producible in as simple a manner as possible, ensuring wide applicability.

Another object of the invention consists in the development of a method as cost-effective as possible for producing such a head model. In this respect, the option of reusing old and worn-out head models should be considered.

With a head model of the initially defined kind, the set object is achieved in that the elements are made of a plastically deformable material. The plastic deformability enables both the representation of the desired hairdo in its natural position and the protection of the cut pattern in any desired direction. After the respective deformation of the elements corresponding to the hairs has been effected, the head model will be available for an extended demonstration period and not only for an instantaneous shot. Such an instructional aid renders feasible both the creation of new hairstyles and the analysis of existing hairdos in an illustrative manner.

If the elements have substantially round cross sections, uniform deformability in all directions will be safeguarded.

A simple and cheap variant of the detachably connection of the elements with the head model is feasible in that, according to a further characteristic feature of the invention, holes are provided in the head model. The holes will offer to the elements the respective support necessary for plastic deformation.

If, as in accordance with a further characteristic feature of the invention, the holes have cross sections tapering towards the interior of the head model, a better clamping effect of the elements in the holes will be reached. The cross sectional taper may, for instance, be conical. The movability of the elements constituting the hairs in the direction of the hole, axis will, thus, be obtained.

A cost-effective variant of the invention is achieved in that the elements are comprised of, preferably insulated, metal wires. In this context, the elements may be prefabricated in certain lengths in order to enable the representation of, for instance, the basic types of hairstyles such as, for instance, a graduated or stepped cut. Color coding of the wires by means of the insulation in the colors usually used in the training of hairdressers will be advantageous, too. The wires also may be continuously available from rolls and cut to length according to demands.

According to another characteristic feature of the invention, sleeves or the like are arranged within the holes. The sleeves or the like ensure precisely defined hole diameters and hence the optimum support of the elements within the holes.

Advantageously, the sleeves or the like are designed to be self-clamping so as to ensure a perfect support of the elements. This may be achieved, for instance, by slightly compressing the end of the sleeve or the like projecting into the head model. In addition, this will enhance the support of the sleeve or the like within the hole.

Alternatively to the above configuration, the sleeves also may be designed to be elastic.

If the sleeves or the like are provided with flanges, this will prevent them from being inserted too deeply into the holes. With the finished head model, the flanges will terminate flush with the surface of the head model.

If the sleeves or the like are provided with notches on their ends to be inserted into the head model, this will ensure a better support of the elements to be inserted in the sleeves or the like, on the one hand, and a better support of the sleeves or the like in the holes of the head model, on the other hand.

According to a further characteristic feature of the invention, it is provided that the sleeves or the like have tapering diameters at least over part of their lengths. This will ensure suitable clamping of the elements within the sleeves or the like.

As far as the related method is concerned, the set object is achieved in that the holes are introduced into the head model made of a thermally deformable material by means of a preheated tool, optionally upon marking of the surface of the head model, and that hair-constituting elements are inserted in at least some of the holes. This renders feasible the reutilization in the production of the head models according to the invention, of, for instance, head models usually used for instruction purposes and equipped with human or synthetic hairs, as these cannot be used for test cuts any longer. To this end, the hairs still attached to the model are removed and the holes intended to receive the elements are produced. Since known head models, as a rule, are made of thermoplastic materials, the production of the holes may be effected in a simple manner by the aid of a preheated tool.

A better support of the elements within the holes will be achieved in that sleeves or the like are introduced into the holes. According to another characteristic feature of the invention, the sleeves or the like are preheated prior to being introduced into the holes.

For a better support of the sleeves or the like in the head model, it is provided that they are glued with the head model.

In order to obtain a better support of the sleeves or the like in the head model and to achieve a clamping effect on the inserted elements, it is provided that the sleeves or the like, prior to being introduced into the holes, are provided with notches, or pressed together, on their ends projecting into the holes. This may be effected in a quick and simple manner by the aid of a suitable tool such as, for instance, pliers.

The invention will be explained in more detail by way of the drawings illustrating an exemplary embodiment of the invention. In the drawings:

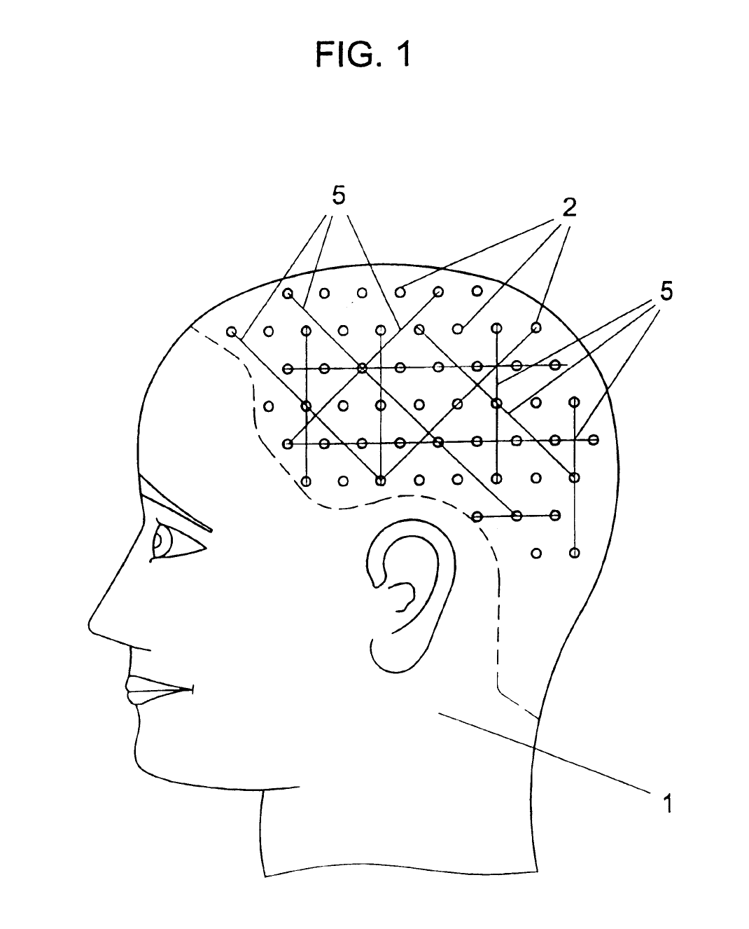

FIG. 1 illustrates an embodiment of a three-dimensional head model comprising means for detachably connecting the elements representing hairs,

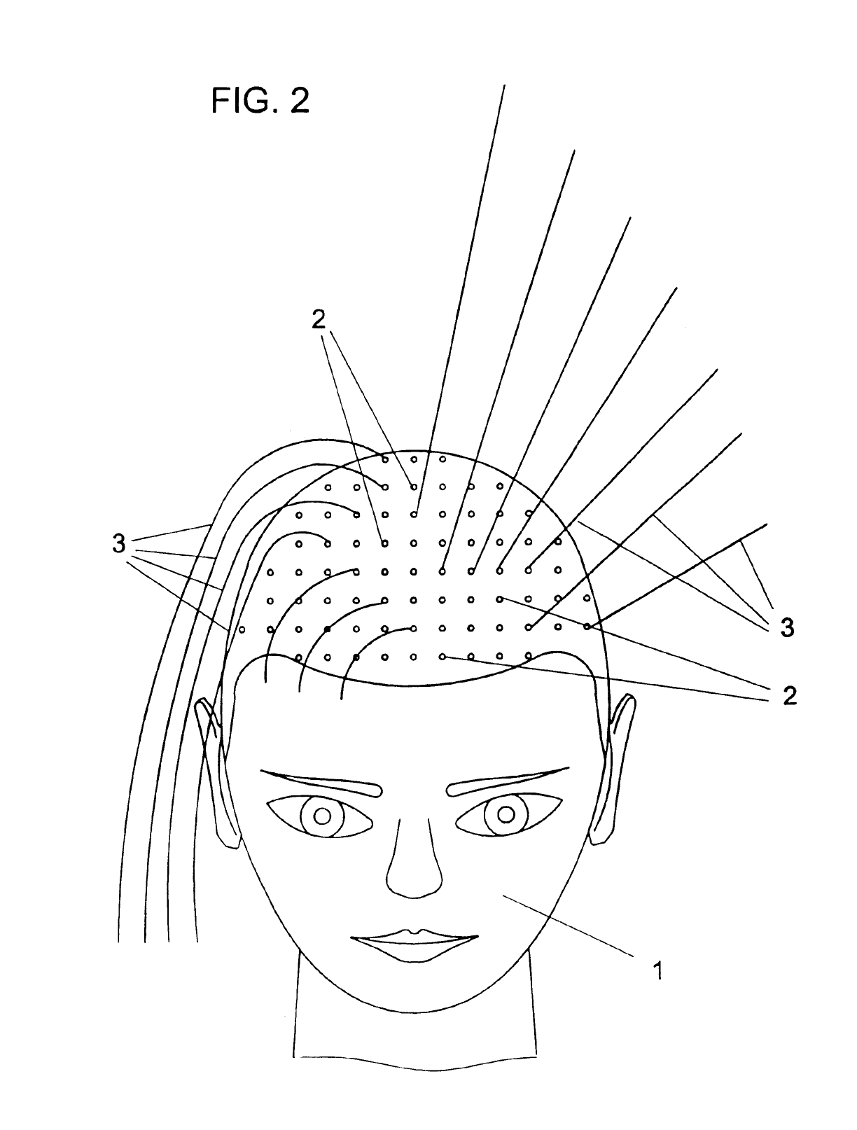

FIG. 2 shows a head model partially provided with elements representing hairs, for use in a cut pattern analysis,

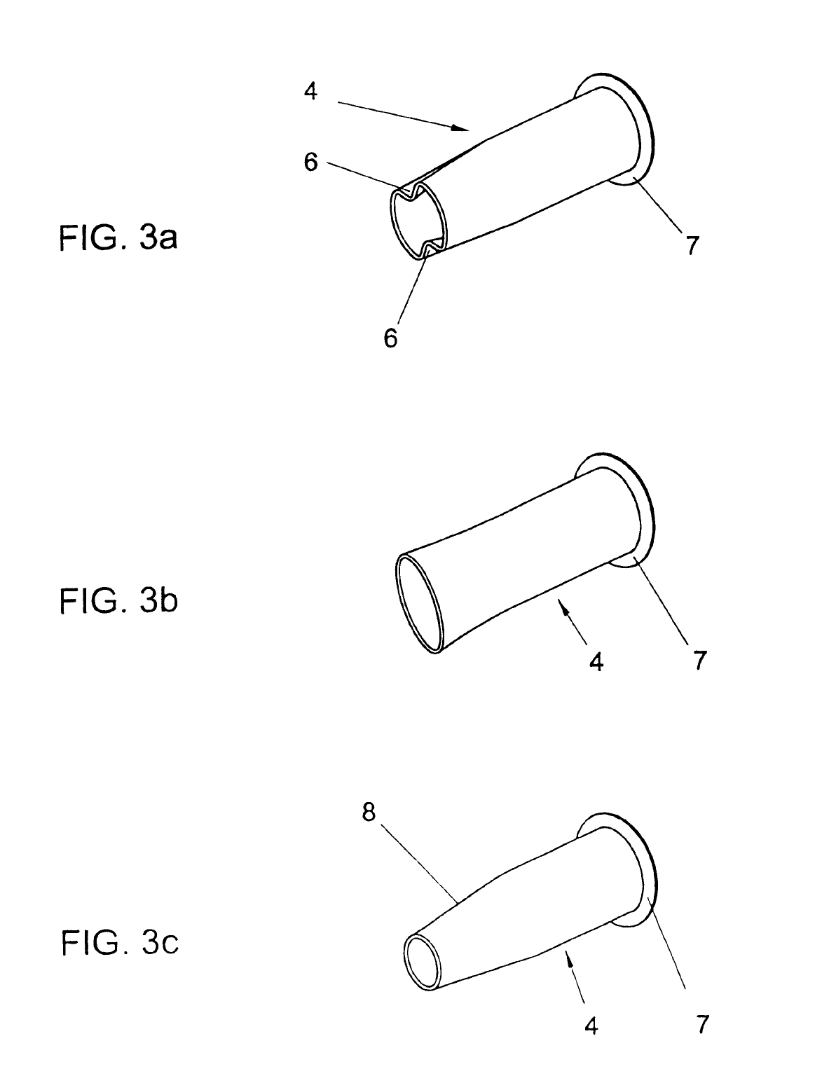

FIGS. 3a to 3c are perspective views of different embodiments of the sleeves,

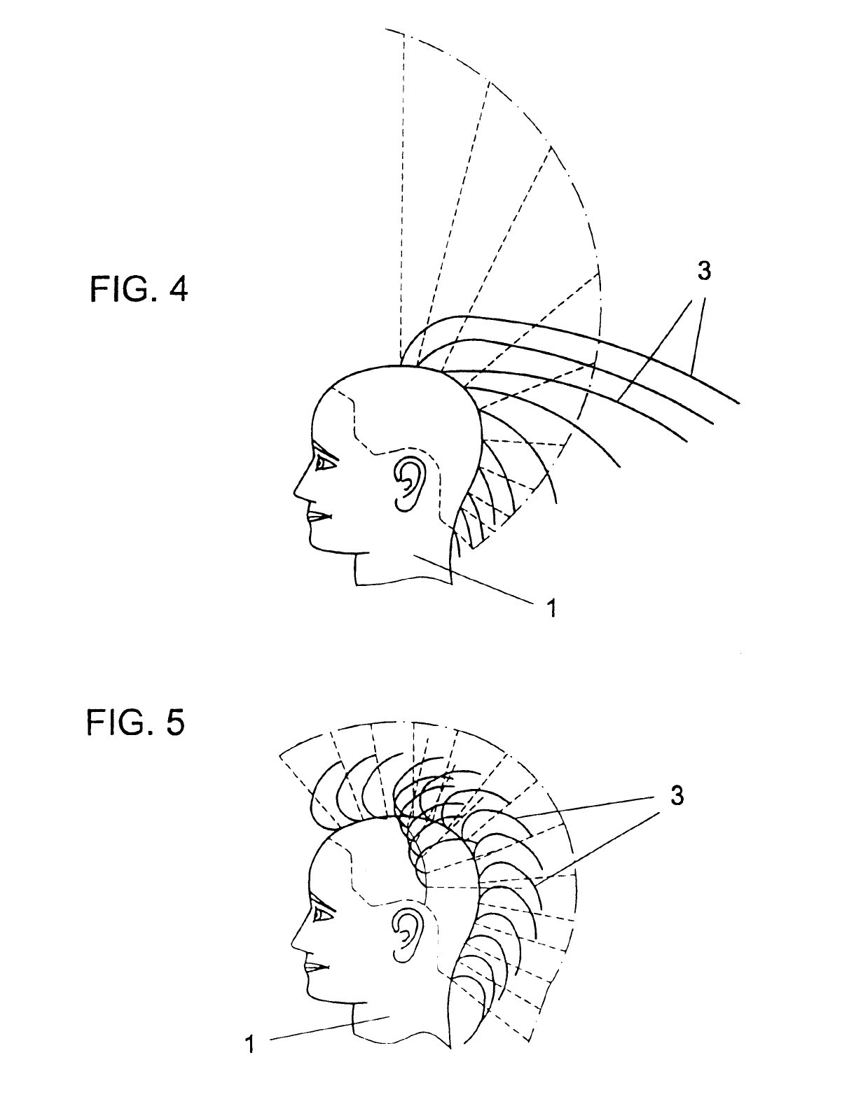

FIGS. 4 and 5 depict two exemplary applications of the head model, and

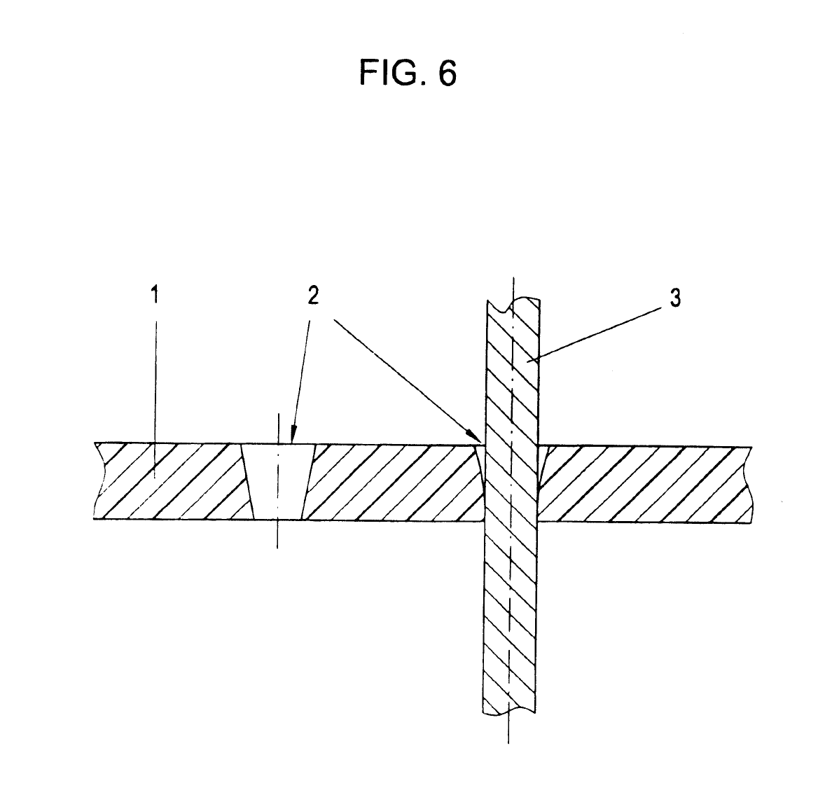

FIG. 6 illustrates a section through a port on of a head model configured differently.

FIG. 1 depicts a three-dimensional head model 1 usually used in the training of hairdressers. In accordance with the invention, the head model 1 is provided with a plurality of holes 2 in which the plastically deformable elements 3 according to the invention are insertable to represent hairs. In order to provide a better support of the elements 3, sleeves 4 or the like may be arranged within the holes 2. The holes 2 preferably are arranged along horizontal, vertical and diagonal lines 5 in accordance with the cutting and projection directions usually used in hairdressing. In an advantageous manner, conventional head models as are used for training purposes of future hairdressers may be used to produce the three-dimensional head models according to the invention. Such head models equipped, for instance, with real or synthetic hair can no longer be used for training purposes after a few cutting procedures. Such head models consequently may be reused by removing the remaining hair and making holes 2 into the surface of the head model 1. To this end, a preheated tool such as, for instance, an appropriately adapted soldering copper is preferably employed. After this, the elements 3 constituting the hairs may be directly inserted into the holes 2 provided on the surface of the head model 1, or sleeves 4 or the like may previously be pressed into the holes 2. Possible sleeves 4 arranged within the holes 2 are preferably made of metal and are preferably preheated prior to being introduced into the holes 2 such that a perfect support will be result upon insertion into the head modes 1. Instead of subsequently introducing the holes 2 into the surface of an existing head model 1, the holes 2 also may be produced simultaneously with the manufacture of the head model 1, for instance, by casting. In doing so, also possible sleeves 4 or the like may be incorporated in one operating step during the casting procedure.

FIG. 2 illustrates the application of a head model 1 according to the present invention, in which some hair-constituting elements 3 are inserted in the holes 2 provided on the head model 1. In accordance with the invention, the elements 3,are made of a plastically deformable material. It is thereby possible, on the one hand, to simulate the shape of a hairdo as shown in the left-hand portion of the Figure, by arranging the elements 3 according to the natural or desired course of the hairs. To this end, the plastically deformable elements 3 are appropriately deformed by hand. In the right-hand portion of FIG. 2, the projection of the hair-constituting elements 3 into a position that corresponds to a cutting direction, is illustrated. Thus, a static three-dimensional model is created by means of the present invention to demonstrate the cutting form or analysis of a haircut. Models used so far have rendered feasible either only two-dimensional representations or only defined projections. By contrast, the head model 1 according to the invention renders feasible both the representation and illustration of the shape of the desired coiffure and the cut courses required to obtain that coiffure. A standardized training of future hairdressers by the aid of the instant head model 1 has, thus, become feasible for the first time.

FIGS. 3a to 3c show different embodiments of the sleeves 4 to be inserted into the holes 2 of the head model 1. The sleeve 4 according to FIG. 3a, on the end oriented in the direction of the head model 1, is provided with notches 6 through which clamping of the elements 3 inserted in the sleeves 4, and hence a better support, will be achieved. With appropriately formed notches 6, also a better support of the sleeve 4 within the hole 2 of the head model 1 will be obtained. The notches illustrated in FIG. 3a may be produced in a particularly simple manner using an appropriate tool, for instance, pliers. In addition to the notches 6, the sleeve 4, on its other end, comprises a flange 7 which, with the sleeve 4 being inserted, terminates flush with the surface of the head model 1. FIG. 3b depicts another embodiment of a sleeve 4, one end of which is pressed together so as to form an oval or elliptical cross section, which offers a better support to the sleeve 4 in the hole 2 and, on the other hand, exerts a clamping effect on an element 3 inserted in the the sleeve 4. Another alternative to these variants is shown in FIG. 3c, in which the sleeve has a tapering cross section over a portion 8 of its length.

FIG. 4 shows the application of a head model 1 according to the present invention for the representation and analysis of a graduated cut in which the length of the hairs, or the elements 3 representing the hairs, increases towards the top portion of the hair such that the tips of the hairs appear to be stacked one upon the other in the resulting hairdo. The broken lines indicate a position of the plastically deformable elements 3 aimed to represent the projection of a cut. The course of the cut is indicated by dot-and-dash lines.

FIG. 5 shows an application of the head model 1 to demonstrate a uniformly stepped haircut in which all of the hair is cut to be substantially equally long. The plastically deformable elements 3 enable the representation of both the cut graphics and the various types of hairstyles resulting therefrom.

FIG. 6 illustrates a section through a part of a head model 1 in which the holes 2 have cross sections tapering towards the interior of the head model 1. The holes 2 may, for instance, be conical. This causes the hair-constituting elements 3 to be clamped automatically. The element 3 may be varied in terms of length by simple displacement in the direction of the hole 2. Different coiffures may thereby be illustrated by varying the lengths of the hair-constituting elements 3. A head model 1 designed in this manner may be manufactured, for instance, by casting of a synthetic material, whereby the holes 2 may already be present in the casting mold or introduced subsequently by means of a suitable tool.

1. A three-dimensional head model (1) to be used as an instructional aid for hairdressers and of the type including a plurality of elements (3) constituting hairs, which elements (3) are detachably connectable with the head model (1), characterized in that holes (2) are provided for the detachable connection of the elements (3), and that the elements (3) are made of a plastically deformable material.

2. A head model according to claim 1, characterized in that the elements (3) have substantially round cross sections.

3. A head model according to claim 1 or 2, characterized in that the holes have cross sections tapering towards the interior of the head model (1).

4. A head model according to any one of claims 1 to 3, characterized in that the elements (3) are comprised of, preferably insulated, metal wires.

5. A head model according to any one of claims 1 to 4, characterized in that sleeves (4) or the like are arranged within the holes (2).

6. A head model according to claim 5, characterized in that the sleeves (4) or the like are designed to be self-clamping.

7. A head model according to claim 5, characterized in that the sleeves (4) or the like are designed to be elastic.

8. A head model according to any one of claims 5 to 7, characterized in that the sleeves (4) or the like are provided with flanges (7).

9. A head model according to any one of claims 5, to 8, characterized in that the sleeves (4) or the like are provided with notches (6) on their ends to be inserted into the head model (1).

10. A head model according to claim 5, characterized in that the sleeves' (4) or the like have tapering diameters at least over part of their lengths.

11. A method for producing a head model according to claims 2 to 10, characterized in that the holes are introduced into the surface of the head model by means of a preheated tool, optionally upon marking of the surface of the head model.

12. A method according to claim 11, characterized in that preheated sleeves or the like are introduced into the holes.

13. A method according to claim 12, characterized in that the sleeves or the like are glued with the head model.

14. A method according to claim 12 or 13, characterized in that the sleeves or the like, prior to being introduced into the holes, are provided with notches, or pressed together, on their ends projecting into the holes.
